(19) United States
(12) Patent Application Publication
(10) Pub. No.: US 2014/0063819 A1
(43) Pub. Date: Mar. 6, 2014

(54) REFLECTOR FOR LIGHT-EMITTING DIODE AND HOUSING

(71) Applicant: Pham Hoai Nam, Shizuoka-shi (JP)

(72) Inventor: Pham Hoai Nam, Shizuoka-shi (JP)

(73) Assignee: DUPONT MITSUI FLUOROCHEMICALS CO LTD, TOKYO (JP)

(21) Appl. No.: 14/114,753

(22) PCT Filed: May 23, 2012
(86) PCT No.: PCT/US12/39220

§ 371 Date: Oct. 30, 2013

(30) Foreign Application Priority Data
May 23, 2011 (JP) 2011-114924

(51) Int. Cl. F21V 7/22

(52) U.S. Cl. CPC F21V 7/22
USPC 362/341

(57) ABSTRACT

Provided is a reflector for a light-emitting diode which has a small decrease in reflectance in a range from the ultraviolet region to visible region, and has excellent heat resistance, light resistance, and weather resistance, and a housing having this reflector. The reflector for a light-emitting diode is obtained by molding a fluororesin composition containing a filler with an average particle diameter of smaller than 1 μm, wherein the difference between the maximum value and the minimum value of the reflectance at a wavelength of 240-700 nm is within 25%.

### FIELD OF INVENTION

The present invention relates to a reflector for a light-emitting diode (alternately referred to herein as LED) having high reflectance, and having a small decrease in reflectance in a range from ultraviolet to visible. The reflector has excellent heat resistance, light resistance, and weather resistance. The present invention further relates to a housing for light-emitting diodes having said reflector.

### BACKGROUND OF INVENTION

Recently, light-emitting diode elements (alternately referred to herein as LED chips) are small in scale and can be it over a long period of time, compared with filament electric bulbs. Since their conversion efficiency of electric energy into a light is high, there is a strong tendency that these elements replace conventional illuminators including a straight tube type fluorescent lamp, and these diode elements are broadly used as electric home appliances, LED displayers, and lighting type operation switches. The usages of LED are divided into general (visible ray) LED and ultraviolet LED by wavelength.

For example, as examples of (visible ray) LED usage, there are dashboards for automobiles, back lights of display devices such as displays (LCD display, monitors for personal computers, small-scale games, and portable phones), indoor illumination sources, indoor and outdoor display devices, and display devices for traffic. In addition, as examples of ultraviolet LED usage include white LED with a high color rendering property in combination with a fluorescent material, paper currency identifiers (sensor light sources for paper currency identification), air cleaners using a photocatalyst (for homes, for vehicle mounting, and for refrigerators), contaminant treatment, fluorescent light sources for biomedical treatment, medical treatment, and analysis in the medical treatment field, sterilization, retention of freshness of vegetables and foods in the foodstuff field, light sources for UV curing such as electronic components and ink, medical treatment equipments, illumination using fluorescent acryl, UV light source monitors, ultraviolet actinometers, spectroscopy, fluorescent material exciting light sources, medical treatment equipment, and light sources for sterilization such as water and air cleaning.

A conventional light-emitting device in which a LED chip is mounted, as shown in FIG. 1 of the instant application, is generally provided with a reflector (3) having a concave aperture part, a LED chip (2) mounted in the concave aperture part, and a curing resin mold (1) for sealing the aforementioned concave aperture part. Said reflector is mounted on a substrate to form a housing (5). Said reflector is a molded product that is obtained by, for example, molding ceramic or white reflecting resin.

Described in Japanese patent no. 4576276 is a LED housing formed of a porous alumina ceramic. The porous alumina ceramic has excellent heat resistance, light resistance, and weather resistance and can obtain high reflectance by controlling the pore diameter and the porosity. In molding of the ceramic, since the ceramic was heated to a temperature of 1,000° C. or higher and baked for a certain time in a batch process, the manufacture cost was high, and the productivity was poor. Recently, continuously moldable thermoplastic resins have been used to lower the manufacture cost of the LED housing. For example, certain polyamide group resins do not melt even at 300° C. However, as shown in Comparative Example 5 of the instant application, when such a resin was heated at 150° C. for 500 h, since the resin was oxidized and discolored to a black color, the reflectance was largely lowered. For this reason, even if the reflectance of the LED housing was high at an initial stage, when a high-output operation was continued, since the resin housing reached a high temperature, the LED housing was discolored, and the luminous efficacy was dropped. In addition, since the polyamide group resin was apt to be degraded at high temperature, when the resin was melted and molded, if the residence time in a melting molding machine was lengthened, the resin was thermally decomposed and discolored, so that the manufacture loss was increased, thereby deteriorating the productivity.

Moreover, as shown in Comparative Example 3 of FIG. 3 of the instant application, in the polyamide group resin, since the reflectance of titanium dioxide as a filler that is used as a reflector is 2.7, the reflectance is high in a visible ray region; however, the reflectance is largely lowered at a wavelength of shorter than 420 nm. The reason for this is considered that the titanium dioxide has a band gap structure of 3.2 eV (as disclosed in Society of Japan Chemistry: Chemistry of Surface Excitation Process, quarterly publication, Chemical General Review no. 12, p. 132-145 (1991)). It is considered that since the absorbed energy is converted into a heat and the titanium dioxide exhibits a photocatalytic action, the degradation of the resin advances.

Furthermore, the development of a white LED in which an ultraviolet LED was combined with fluorescent materials with three colors of red, green, and blue has recently been advanced, and owing to its excellent color rendering property, its development to general illumination usages is expected. In this system, since the wavelength of an excitation light source is further shortened from 460 nm of a blue color to 405 nm, the housing member is likely to be further degraded beyond the current level, thus being unable to expect a long life of the LED housing. For these reasons, fluororesins, which have excellent characteristics such as heat resistance, light resistance, weather resistance, chemical resistance, high-frequency electric property, and flame retardation and are broadly used in pipes for transfer of medicinal liquids, solvents, and paints such as acids and alkalis, chemical industrial manufacture goods such as medicinal liquid storage containers or tanks, or electric industrial goods such as tubes, rollers, and electric wires, for example, polytetrafluoroethylene (PTFE) or tetrafluoroethylene-perfluoro(alkylvinyl ether) copolymer (PFA), tetrafluoroethylene-hexafluoropropylene copolymer (FEP), and tetrafluoroethylene-hexafluoropropylene-perfluoro(alkylvinyl ether) copolymer (EPE) of heat-fusible fluororesin, etc., are reviewed as resins of utility for LED reflectors.

In US2010/0032702A1, a reflector for LED composed of a fluororesin containing titanium dioxide as a filler is presented. However, like the aforementioned polyamide group resin (Comparative Example 3 of the instant application), since the titanium dioxide for absorbing ultraviolet rays is used as a filler, the reflectance in an ultraviolet region is largely lowered (see Comparative Example 2 of the instant application), and this fluororesin cannot be used in a reflector for ultraviolet LED and a reflector for white LED in which a rear-ultraviolet LED is combined with fluorescent materials with three colors of red, green, and blue. For this reason, a reflector for LED, which has no absorption in a range from ultraviolet to a visible, that is, without largely lowering the reflectance in an ultraviolet region, has excellent heat resistance, light resistance, and weather resistance, and has high reflectance, and a housing having such a reflector are in demand.

### SUMMARY OF INVENTION

According to the present invention, a reflector for LED, which did not lower the reflectance in a range from an ultraviolet region to a visible region and had excellent heat resistance, light resistance, and weather resistance, and a housing were reviewed in earnest. As a result, a method that can solve the aforementioned problems was discovered, leading to the completion of the present invention.

The present invention provides a reflector that does not lower the reflectance in a range from an ultraviolet region to a visible region and has excellent heat resistance, light resistance, and weather resistance.

In addition, the present invention relates to a reflector for a light-emitting diode with high reflectance (a reflectance of 70% or more) in a range from an ultraviolet region to a visible ray region. Moreover, the present invention provides a housing having said reflector for LED.

In a reflector for LED that is obtained by molding a fluororesin composition containing a filler with an average particle diameter of smaller than 1 μm, the present invention provides said reflector for LED in which the difference between the maximum value and the minimum value of the reflectance at a wavelength of 240-700 nm is within 25%.

In the aforementioned reflector, a reflector for LED, in which the fluororesin is a homopolymer of tetrafluoroethylene and/or at least one kind that is selected from a copolymer of tetrafluoroethylene and at least one kind of monomer that is selected from hexafluoropropylene, chlorotrifluoroethylene, perfluoro(alkylvinyl ether), vinylidene fluoride, vinyl fluoride, ethylene, and propylene, is a preferable fluororesin of the present invention. In the aforementioned reflector, a reflector for LED, in which the refractive index of the filler with an average particle diameter of smaller than 1 μm is 1.5 or greater, is a preferable embodiment of the present invention.

In the aforementioned reflector, a reflector for LED, in which the filler with an average particle diameter of smaller than 1 μm is a metal or metal oxide, is a preferable embodiment of the present invention.

In the aforementioned reflector, a reflector for LED, in which the metal or metal oxide is at least one kind that is selected from crystal system α-alumina, vanadium dioxide, zirconium dioxide, and tantalum pentaoxide, is a preferable embodiment of the present invention.

In the aforementioned reflector, a reflector for LED, in which the reflectance at a wavelength of 240-380 nm is 70% or more, is a preferable embodiment of the present invention.

In the aforementioned reflector, a reflector for LED, which is obtained by molding a fluororesin composition containing crystal system α-alumina particulates with an average particle diameter of 0.1-1.0 μm, is a preferable embodiment of the present invention.

In the aforementioned reflector, a reflector for LED, in which the content of the filler with an average particle diameter of smaller than 1 μm is 0.1-50 mass % to the entire fluororesin composition, is a preferable embodiment of the present invention.

In addition, the housing having the aforementioned reflector for LED is a preferable embodiment of the present invention.

According to the present invention, a reflector for LED, which does not lower the reflectance in a range from an ultraviolet region to a visible region and has excellent heat resistance, light resistance, and weather resistance, and a housing having said reflector are provided.

Since the reflectance is not lowered, a fixed reflectance can be obtained without depending upon the wavelength of LED to be used.

In addition, since the filler with an average particle diameter of smaller than 1 μm is uniformly dispersed into the reflector, a high reflectance can be realized by the filler at an amount smaller than that of conventional reflectors.

### BRIEF DESCRIPTION OF THE DRAWINGS

Embodiments are illustrated in the accompanying figures to improve understanding of concepts presented herein.

FIG. 1 is an outlined diagram showing the housing having the reflector for LED. In FIG. 1, 1 is the sealant, 2 is the LED chip, 3 is the reflector, 4 is the substrate, and 5 is the housing.

FIG. 2 is an outlined diagram showing the reflector for LED with a tape shape. In FIG. 2, 1 is the sealant, 2 is the LED chip, 3 is the reflector, 4 is the substrate, and 6 is the gap.

FIG. 3 is a graph showing the wavelength dependency of the reflectance of molded products.

FIGS. 4A and 4B are photos showing a fracture surface of a composite composition of Application Example 3 obtained by an electron microscope.

FIGS. 5A and 5B are photos showing a fracture surface of a composite composition of Comparative Example 1 obtained by the electron microscope.

### DETAILED DESCRIPTION OF INVENTION

The fluororesin, which is used in the present invention, is a melt-moldable fluororesin. The melt molding is a molding method using a conventional weft-known melt-molding machine. It means that since the polymer flows in a molten state, a molded product exhibiting sufficient strength and durability corresponding to each prescribed purpose, such as film, fiber, and tube, can be obtained from the melted substance.

The melt-moldable fluororesin is a copolymer (TFE copolymer) of tetrafluoroethylene (TFE) and at least one kind of copolymerizable fluorinated monomer (comonomer), and at least one kind of copolymerizable fluorinated monomer (comonomer) exists at an amount, which is sufficient for obtaining a melting point substantially lower than the melting point (315° C.) of the homopolymer (polytetrafluoroethylene (PTFE)) of TFE, in the polymer.

The melt-moldable fluororesin, which is appropriately used in the present invention, is a copolymer of at least about 40-98 mol % TFE unit and at least one kind of another monomer copolymerizable with about 2-60 mol % TFE. As the monomer copolymerizable with TFE, for example, hexafluoropropylene (HFP), perfluoro(alkylvinyl ether) (PAVE) (the alkyl group is a straight-chain or branched alkyl group with 1-5 carbons), etc., can be mentioned. As the PAVE monomer, a PAVE monomer containing an alkyl group with the number of carbon of 1, 2, 3, or 4 is preferable. The TFE copolymer may also be a copolymer of several kinds of PAVE monomers and TFE. PAVE of the TFE copolymer is preferably 1-20 mass %.

Mentioned as preferable TFE copolymers are FEP (TFE/HFP copolymer), PFA (TFE/PAVE copolymer), TFE/HFP/PAVE copolymer, where PAVE is perfluoro(ethylvinyl ether) (PEVE) and/or perfluoro(propylvinyl ether) (PPVE), MFA (TFE/perfluoro(methyvinyl ether) (PMVE)/PAVE copolymer, where the alkyl group of PAVE has 2 or more carbon atoms), THV (TFE/HFP/vinylidene fluoride (VF2) copolymer), etc. More preferably, PFA (TFE/PAVE copolymer) is mentioned.

The fluororesin, which is used in the present invention, may also be used by mixing several kinds of TFE copolymers.

The TFE copolymer has a melt flow rate (MFR) of about 0.5-100 g/10 min, preferably 0.5-50 g/10 min, which is measured at a standard temperature of said specific TFE copolymer according to ASTM D-1238.

In addition, the melt viscosity of the TFE copolymer is measured at 372° C. by the modified method of ASTM 0-1238, which is described in U.S. Pat. No. 4,380,618, and is at least 10² Pa·s, preferably 10² Pa·s about10⁶ Pa·s, and more preferably about 10³-10⁵ Pa·s.

The content of the TFE copolymer in the fluororesin composition is 50-99.9 mass %, preferably 60-99 mass %, and more preferably 70-95 mass %.

The form of the melt-moldable fluororesin is not particularly limited as long as it is suitable for melt-molding, and all forms such as powder-shaped substance, granulated product of powder-shaped substance, particle-shaped substance, flake, pellet, and bead can be mentioned.

The filler with an average particle diameter of smaller than 1 μm, which is used in the present invention, is preferably a light-reflecting compound with high refractive index and high reflectance in a range from an ultraviolet region to a visible region. The average particle diameter of this light-reflecting compound is 0.01-1.0 μm, preferably 0,1-1.0 μm, and more preferably 0.2-1.0 μm. If the average particle diameter of the light-reflecting compound is greater than 1.0 μm, the light scattering effect is lowered, lowering the reflectance. The average particle diameter, for example, can be measured by particle size analyzer (for example, made by CILAS Co., CILAS 990, CILAS 1090, and CILAS 1190; ISO 13320), etc. As such a filler, products available on the market (for example, made by Almatis, Inc., A16GS) can also be used.

The mixed state of the filler in the molded product can be observed by using a field radiation type scanning electron microscope (for example, SEM, made by Hitachi, Ltd., 5-4500).

The refractive index of the filler is preferably 1.5 or greater. If the refractive index is smaller than 1 undesirably, a high reflectance cannot be obtained.

In addition, the band gap of the filler with a refractive index of 1.5 or greater is preferably 4.0 eV or higher. If the filler has a band gap of higher than 4.0 eV, since it absorbs light in a wavelength range of 320-700 nm similarly to a photocatalyst, a sufficient reflectance cannot be obtained at a short wavelength of 240 nm (as disclosed in Society of Japan Chemistry: Chemistry of Surface Excitation Process, quarterly publication, Chemical General Review no. 12, p. 132-145 (1991))).

As such a filler, metals or metal oxides are of utility. For example, crystal system α-alumina Al₂O₃ (refractive index: 1.7, band gap: 8.8 eV), hafnium dioxide HfO₂ (refractive index: 1.7, band gap: 5.5 eV), zirconium dioxide ZrO₂ (refractive index: 1.9, band gap: 4.6 eV), Ta₂O₅ (refractive index: 2.2, band gap: 4.2 eV), etc., are of utility. More preferably the filler is α-alumina.

The filler in the fluororesin composition is 0.1-50 mass %, preferably 1-40 mass %, and more preferably 5-30 mass %. If the filler is less than 0.1 mass %, a high reflectance cannot be obtained. On the other hand, if the ratio of the filler exceeds 50 mass %, the melt viscosity of the fluororesin composition is raised, making the injection molding difficult, thereby lowering the strength and the durability of the molded product to be obtained.

The TFE copolymer and the filler may be mixed before melt-molding or at the same time of melt-molding. In addition, general mixing methods can be employed as the mixing method. For example, well-known traditional dispersers and mixers such as co-cohesion method (Japanese Kokai Patent Application No. 2007-119769), planetary mixer, high-speed impeller disperser, rotary drum type mixer, screw type mixer, belt conveyor mixing system, ball mill, pebble mill, sand mill, roll mill, attriter, and bead mill can be adopted. Apparatuses that can uniformly disperse the TFE copolymer and the filler are more preferable.

As the form of the fluororesin composition that is obtained by mixing the TFE copolymer and the filler before melt-molding, all forms such as powder-shaped substance, granulated product of powder-shaped substance, particle-shaped substance, flake, pellet, and bead are of utility.

In addition to the aforementioned mixing methods, there are also the following wet-mixing methods. For example, if the filler is dissolved in an aqueous solution or organic solution acting as a carrier and sprayed on the TFE copolymer, a TFE copolymer coated with the filler can be obtained. The organic solvent is not particularly limited. For example, methanol, ethanol, chloroform, acetone, toluene, etc., are of utility. In addition, organic solvents with high solubility in the filler are preferable.

As the melt-molding method of the fluororesin composition, conventional well-known molding methods can be employed. For example, compression molding, extrusion molding, transfer molding, blow molding, injection molding, rotation molding, lining molding, foamed body extrusion molding, film molding, etc., are of utility, with the extrusion molding or injection molding being preferable.

The molded product, which is obtained by the aforementioned melt-molding method, is a molded product that does not lower the reflectance in a range from an ultraviolet region to a visible region, has excellent heat resistance, light resistance, and weather resistance, and has high reflectance in a range from an ultraviolet region to a visible ray region. The difference between the maximum value and the minimum value of the reflectance of the molded product in a wavelength range of 240-700 nm, which is measured by a measuring method that will be mentioned later, is within 25%, thus being able to obtain a stable reflectance. In addition, the reflectance of the molded product in a wavelength region of 240-700 nm is 70% or more.

The reflectance of the molded product at a wavelength of 240-700 nm can be obtained by measuring the reflectance of a sample with a thickness of about 1.5 mm prepared by melt-compression molding under the following conditions. Using a method that irradiates light with a wavelength of 240-700 nm at an angle of incidence of 10 degrees to a reflective layer of the sample surface and lets transmitting light escape, without installing a reflecting plate on the back of the sample, the spectral reflectance (a relative reflectance using a standard white plate as a control) including a regular reflection component and a diffused reflection component was measured at each wavelength by a spectrophotometer in which an integrating sphere was mounted in a detector (U-4100 made by Hitachi. Ltd.).

With the use of said molded product as a reflector for LED, a housing for an light-emitting diode, which does not lower the reflectance in a range from an ultraviolet region to a visible region, has excellent heat resistance, light resistance, and weather resistance, and has high reflectance in a range from an ultraviolet region to a visible ray region, can be obtained.

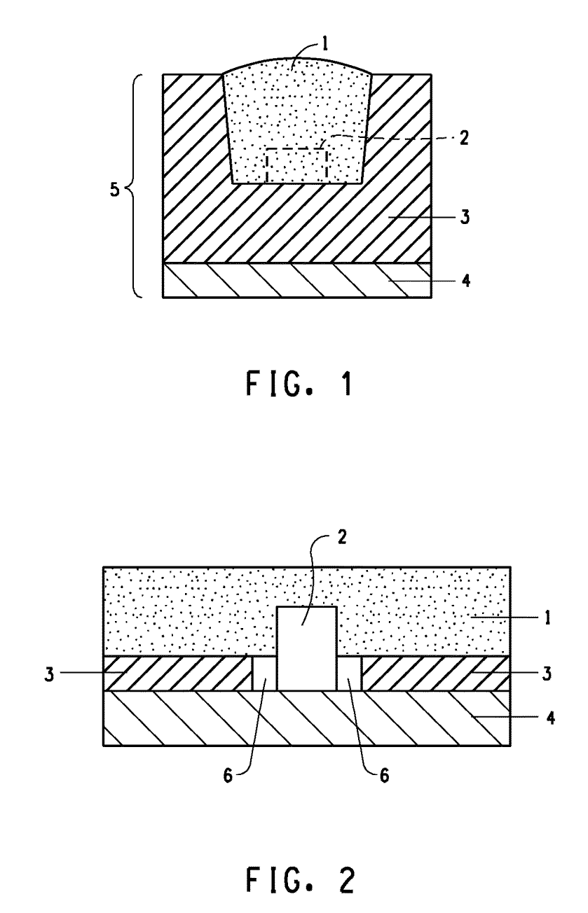

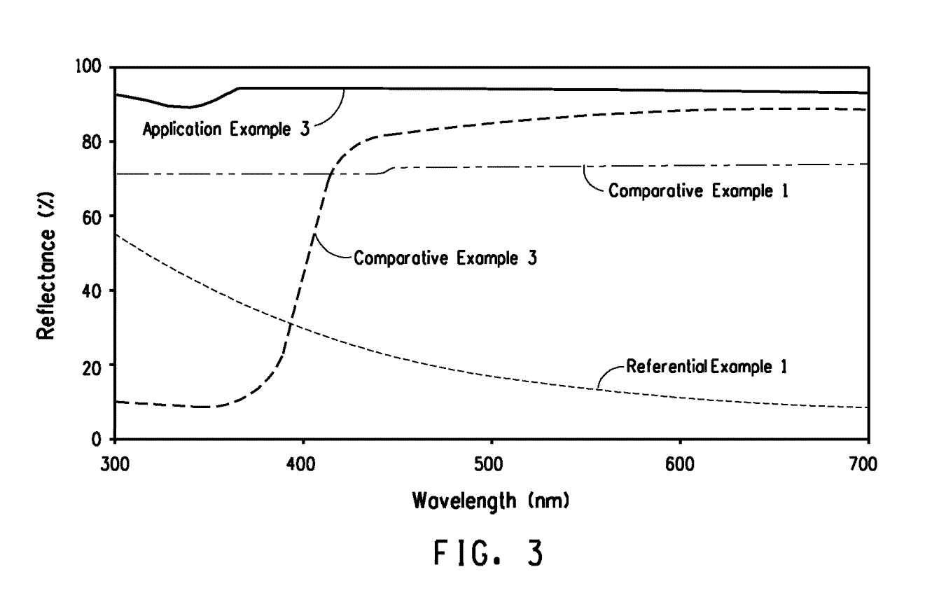

In addition, the shape of the reflector for LED in the present invention is not particularly limited. In addition to the concave shape shown in FIG. 1, for example, as shown in FIG. 2, in case several LED light-emitting devices are arranged on a tape-shaped or sheet-shaped flexible substrate, it can also be used as a cover layer that is a single film and has insulating, adhesion, and reflector functions.

In the present invention, the housing indicates a housing in which the reflector mounted with a LED chip is mounted on a substrate. Here, the LED chip is sealed with a sealant.

### EXAMPLES

Next, the present invention will be explained in further detail by application examples and comparative examples; however, the present invention is not limited by this explanation.

Each property in the present invention was measured by the following methods.
A. Measurement of Properties

(1) Melting Point (Melting Peak Temperature)

A differential scanning calorimeter (Pyris 1 type DSC, made by Perkin Elmer Co.) was used. About 10 mg sample was weighed, put into a dedicated aluminum pan, crimped by a dedicated crimper, and housed in the DSC body, and the temperature was raised at 10° C./min from 150° C. to 360° C. At that time, the melting peak temperature (Tm) was attained from the melting curve obtained.

(2) Melt Flow Rate (MFR)

Using a melt indexer (made by Toyo Seiki Co., Ltd.) with a corrosion-resistant cylinder, die, and piston based on ASTM D-1238-95, 5 g sample powder was filled in the cylinder held at 372±1° C., held for 5 min, and extruded through a die orifice under a load (piston and weight) of 5 kg. At that time, the extrusion rate (g/10 min) was attained as melt flow rate (MFR).

(3) Reflectance Measurement

The reflectance of a sample with a thickness of about 1.5 mm prepared by melt-extrusion molding was measured under the following conditions.

Using a method that irradiates light with a wavelength of 240-700 nm at an angle of incidence of 10 degrees to a reflective layer of the sample surface and lets transmitting lights escape, without installing a reflecting plate on the back of the sample, the spectral reflectance (a relative reflectance using a standard white plate as a control) including a regular reflection component and a diffused reflection component was measured at each wavelength by a spectrophotometer in which an integrating sphere was mounted in a detector (U-4100 made by Hitachi, Ltd.).

(4) Heat Treatment Test

Samples with a thickness of about 1.5 mm prepared by melt-compression molding were put into a hot-air circulation type oven (ESPEC SUPER-TEM. OVEN STPH-101) whose temperature was raised to 150° C. and heat-treated.

(5) Melt-Kneading Test

A fluororesin and a filler with compositions shown in Table 1 were melt-kneaded at 350° C., which was higher than the fluororesin melting point (about 308° C.) by about 40° C., at 100 rpm for 5 min by using a melt-kneader (made by Tow Seiki Works K.K., KF-70 V small-scale segment mixer) in combination of shears in which the phase of five sheets of kneading discs was shifted by 2 pitch.

(6) Dispersed State Observation of Filler

From the observation of a fracture surface of a sample with a thickness of about 1.5 mm prepared by melt-compression molding the aforementioned fluororesin composite composition at 350° C. through a scanning electron microscope (SEM, made by Hitachi Ltd., S-4500), a uniform dispersed state of the filler was evaluated, and the size of primary particles of the filler was summarized in Table 1.
B. Raw Materials

Raw materials used in the application examples of the present invention and the comparative examples are as follows.

(1) Perfluorofluororesin (TFEIPAVE copolymer, PFA) The TFE/PAVE copolymer used in these application examples was a fluororesin PFA (PFA440HPJ made by DuPont-Mitsui Fluorochemicals Co., Ltd.) with a melting point of 308° C. and a melt flow rate of 15 g/10 min.

(2) The polyphthalamide (PPA) composite used in Comparative Examples 3, 4, and 5 was Amodel polyphthalamide with a melting point of 324° C. (made by Solvay Advanced Polymers, A-4122 NLWH 905).

(3) Filler

a) α-alumina: made by Nippon Light Metal Co., Ltd., A31, an average particle diameter of 5.2 μm

b) α-alumina: made by Almatis, Inc., A16GS, an average particle diameter of 0.5 μm

c) titanium dioxide: made by Fuji Titanium K.K., TA-300 an average particle diameter of 0.3 μm

### Application Examples 1-3

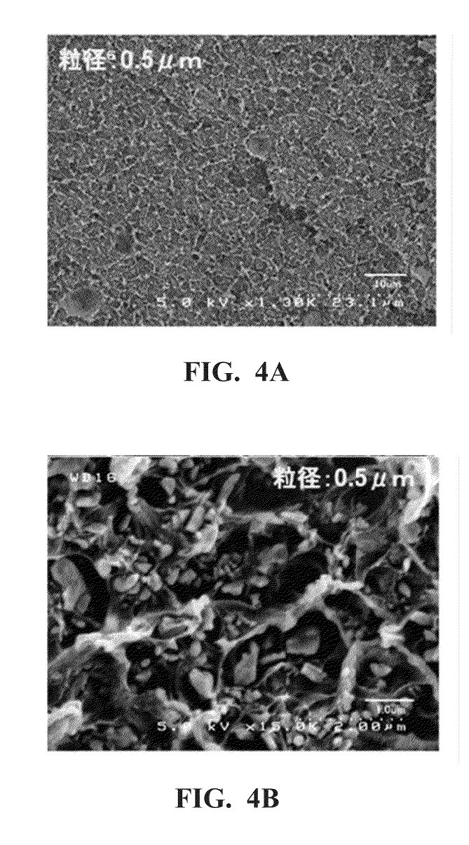

Alumina (A16GS) and fluororesin PFA with compositions shown in Table 1 were melt-kneaded at 350° C. and 100 rpm for 5 min by using the melt-kneader (made by Toyo Seiki Works K.K., KF-70 V small-scale segment mixer) in combination of shears in which the phase of five sheets of kneading discs was shifted by 2 pitch, so that mixed compositions were obtained. From the fracture surfaces of the composite compositions (FIGS. 4A and 4B) obtained, the alumina dispersed state was evaluated by an electron microscope. As a result, it was understood that the alumina was uniformly dispersed into FFA. In addition, the composite compositions underwent melt-compression molding at 350° C. to prepare samples with a thickness of about 1.5 mm. The reflectance of the samples was measured at standard temperature. The results obtained were summarized in Table 1.

### Application Example 4

The composite composition prepared by Application Example 3 underwent melt-compression molding at 350° C. to prepare a sample with a thickness of about 1.5 mm. The sample obtained was put into a hot-air circulation type oven, whose temperature was raised to 150° C., and then heat-treated for 100 h, and the reflectance of the sample was measured at standard temperature. The results obtained were summarized in Table 2.

### Application Example 5

The composite composition prepared by Application Example 3 underwent melt-compression molding at 350° C. to prepare a sample with a thickness of about 1.5 mm. The sample obtained was put into a hot-air circulation type oven, whose temperature was raised to 150° C., and then heat-treated for 500 h, and the reflectance of the sample was measured at standard temperature. The results obtained were summarized in Table 2.

### Comparative Example 1

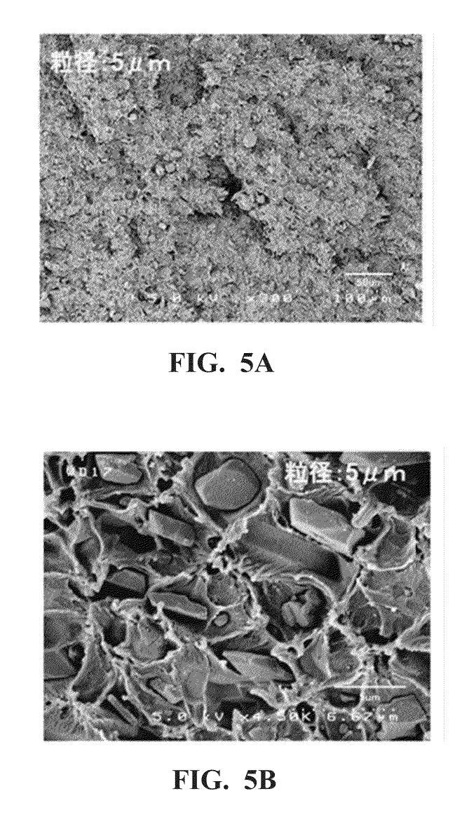

Alumina (A31) and fluororesin PFA with compositions shown in Table 1 were melt-kneaded at 350° C. and 100 rpm for 5 min by using the melt-kneader (made by Toyo Seiki Works K.K., KF-70 V small-scale segment mixer) in combination of shears in which the phase of five sheets of kneading discs was shifted by 2 pitch, so that a mixed composition was obtained. From the fracture surface of the composite composition (FIGS. 5A and 5B) obtained, the alumina dispersed state was evaluated by an electron microscope. As a result, it was understood that the alumina was uniformly dispersed into PFA. In addition, the composite composition underwent melt-compression molding at 350° C. to prepare a sample with a thickness of about 1.5 mm. The reflectance of the sample was measured. The results obtained were summarized in Table 1.

### Comparative Example 2

Titanium dioxide (TA-300) and fluororesin with compositions shown in Table 1 were melt-kneaded at 350° C. and 100 rpm for 5 min by using the melt-kneader (made by Toyo Seiki Works K.K., KF-70 V small-scale segment mixer) in combination of shears in which the phase of five sheets of kneading discs was shifted by 2 pitch, so that a mixed composition was obtained. From the fracture surface of the composite composition obtained, the alumina dispersed state was evaluated by an electron microscope. As a result, it was understood that the titanium dioxide was uniformly dispersed into PFA. In addition, the composite composition underwent melt-compression molding at 350° C. to prepare a sample with a thickness of about 1.5 mm. The reflectance of the sample was measured. The results obtained were summarized in Table 1.

### Comparative Example 3

A PPA composite underwent melt-compression molding at 340° C. to prepare a sample with a thickness of about 1.5 mm. The reflectance of the sample obtained was measured. The results obtained were summarized in Table 2.

### Comparative Example 4

The sample prepared under the same conditions as those of Comparative Example 3 was put into a hot-air circulation type oven, whose temperature was raised to 150° C., and then heat-treated for 100 h, and the reflectance of the sample was measured at standard temperature. The results obtained were summarized in Table 2.

### Comparative Example 5

The sample prepared under the same conditions as those of Comparative Example 3 was put into a hot-air circulation type oven, whose temperature was raised to 150° C., and then heat-treated for 500 h, and the reflectance of the sample was measured at standard temperature. The results obtained were summarized in Table 2.

### Referential Example 1

A fluororesin PFA440HN underwent melt-compression molding at 350° C. to prepare a sample with a thickness of about 1.5 mm. The reflectance of the sample obtained was measured. The results obtained were summarized in Table 1.

### Dependency of the Reflectance on the Amount of Alumina Added

In Application Example 1, it was understood that when 5 mass % alumina particles with a particle diameter of 0.5 μm were uniformly dispersed into PFA, a reflectance of 70% was exhibited without absorbing lights in a range of a wavelength measurement (240-700 mm). In addition, as shown in Application Examples 1-3, when the amount of alumina addition was increased up to 20 mass %, the reflectance at each wavelength reached a level of 90% or more. As shown in FIG. 3 and Table 1, the fluororesin (Referential Example 1) had high transmittance of light and exhibited low reflectance, especially in a visible ray region, and when alumina as a light-reflecting material was added, the reflectance was raised.

### Alumina Particle Diameter Dependency of Reflectance

In Application Example 3, when 20 mass % alumina particles were uniformly dispersed, a reflectance of 90% or more was exhibited in a wavelength region of 240-700 nm. On the other hand, when alumina with a particle diameter of 5 μm, which was the same crystal (α-alumina) as the alumina used in Application Example 3, was added at the same amount of addition (20 mass %), only a reflectance of 70% was exhibited. Therefore, it was understood that when the particle diameter of the alumina was decreased from 5 μm to 0.5 μm, the reflectance was raised by about 20%.

### Light Reflection Behavior of Alumina

In Application Example 3, when 20 mass % alumina particles were uniformly dispersed into PFA, a reflectance of 90% or more was exhibited without absorbing lights in a wavelength region of 240-700 nm. On the other hand, as shown in Comparative Example 2 and FIG. 3, when 20 mass % titanium dioxide was uniformly dispersed into PFA, a reflectance of 90% or more was exhibited in a visible ray region (400-700 nm); however, since the titanium dioxide absorbed light in an ultraviolet region, only a reflectance of several % was exhibited in a region of 400 nm or shorter.

### Heat Treatment Time Dependency of Reflectance

In Application Examples 4 and 5, it was understood that the reflectance was little changed by a continuous heat treatment at 150° C. for 100 h or 500 h. On the other hand, in Comparative Examples 4 and 5, when the PPA composite was heat-treated under the same conditions as those of Application Examples 4 and 5, the samples were discolored, and the reflectance in a visible ray region was largely dropped as shown in FIG. 3.

TABLE 1
Table 1: Reflectance of molded products and filler dispersed state

| | | | | Particle | | | | | | | |
|---|---|---|---|---|---|---|---|---|---|---|---|
| | Composition (wt %) | | | diameter | Filler | | | | | | |
| | | | Titanium | of filler | dispersed | Reflectance at each wavelength (%) | | | | | |
| | PFA | Alumina | dioxide | (μm) | state | 300 nm | 350 nm | 380 nm | 410 nm | 500 nm | 700 nm |
| Application | 95 | 5 | 0 | 0.5 | ◯ | 70.2 | 69.0 | 70.1 | 72.0 | 77.1 | 82.4 |
| Example 1 | | | | | | | | | | | |
| Application | 85 | 15 | 0 | 0.5 | ◯ | 81.8 | 80.0 | 80.6 | 81.5 | 84.4 | 90.6 |
| Example 2 | | | | | | | | | | | |
| Application | 80 | 20 | 0 | 0.5 | ◯ | 93.3 | 90.4 | 94.3 | 94.4 | 94.2 | 93.5 |
| Example 3 | | | | | | | | | | | |
| Comparative | 80 | 20 | 0 | 5 | ◯ | 70.3 | 69.7 | 70.6 | 70.9 | 72.5 | 74.0 |
| Example 1 | | | | | | | | | | | |
| Comparative | 80 | 0 | 20 | 0.3 | ◯ | 4.5 | 7.0 | 62.4 | 93.5 | 95.7 | 96.1 |
| Example 2 | | | | | | | | | | | |
| Referential | 100 | 0 | 0 | — | — | 55.4 | 40.2 | 33.9 | 28.7 | 17.5 | 7.9 |
| Example 1 | | | | | | | | | | | |

TABLE 2
Table 2: Reflectance of heat-untreated and heat-treated molded products

| | Resin | Heat treatment | Reflectance at each wavelength (%) | | | | | |
|---|---|---|---|---|---|---|---|---|
| | base | time (hr) | 300 nm | 350 nm | 380 nm | 410 nm | 500 nm | 700 nm |
| Application | PFA | 0 | 93 | 90 | 94 | 94 | 94 | 94 |
| Example 3 | | | | | | | | |
| Application | PFA | 100 | 92 | 90 | 93 | 94 | 94 | 94 |
| Example 4 | | | | | | | | |
| Application | PFA | 500 | 92 | 90 | 94 | 94 | 94 | 94 |
| Example 5 | | | | | | | | |
| Comparative | PFA | 0 | 8 | 8 | 14 | 64 | 84 | 89 |
| Example 3 | | | | | | | | |
| Comparative | PFA | 100 | 8 | 8 | 14 | 52 | 68 | 87 |
| Example 4 | | | | | | | | |
| Comparative | PFA | 500 | 8 | 7 | 14 | 41 | 56 | 78 |
| Example 5 | | | | | | | | |

1. A reflector for a light-emitting diode, which is obtained by molding a fluororesin composition containing a filler with an average particle diameter of smaller than 1 μm; said reflector for a light-emitting diode is constituted in such a manner that the difference between the maximum value and the minimum value of the reflectance at a wavelength of 240-700 nm is within 25%.

2. The reflector for a light-emitting diode of claim 1, wherein the fluororesin is a homopolymer of tetrafluoroethylene and/or at least one kind that is selected from a copolymer of tetrafluoroethylene and at least one kind of monomer that is selected from hexafluoropropylene, chlorotrifluoroethylene, perfluoro(alkylvinyl ether), vinylidene fluoride, vinyl fluoride, ethylene, and propylene.

3. The reflector for a light-emitting diode of claim 1, wherein the refractive index of the filler with an average particle diameter of smaller than 1 μm is 1.5 or greater.

4. The reflector for a light-emitting diode of claim 1, wherein the filler with an average particle diameter of smaller than 1 μm is a metal or metal oxide.

5. The reflector for a light-emitting diode of claim 4, wherein the metal or metal oxide is at least one kind that is selected from crystal system α-alumina, vanadium dioxide, zirconium dioxide, and tantalum pentaoxide.

6. The reflector for a light-emitting diode of claim 1, wherein the reflectance at a wavelength of 240-380 nm is 70% or more.

7. The reflector for a light-emitting diode of claim 1, which is obtained by molding a fluororesin composition containing crystal system α-alumina particulates with an average particle diameter of 0.1-1.0 μm.

8. The reflector for a light-emitting diode of claim 1, wherein the content of the filler with an average particle diameter of smaller than 1 μm is 0.1-50 mass % to the entire fluororesin composition.

9. A housing, having the reflector for a light-emitting diode of claims 1.
